(19) United States
(12) Patent Application Publication
(10) Pub. No.: US 2003/0168770 A1
(43) Pub. Date: Sep. 11, 2003

(54) Method of manufacturing footprint tiles

(76) Inventor: Charles Young, Auburn, NY (US)

Correspondence Address: Charles Young, 3100 Frankling Street Road, Auburn, NY, 13021, US

(21) Appl. No.: 10/047,203

(22) Filed: Jan. 17, 2002

(51) Int. Cl. B29C 59/04

(52) U.S. Cl. 264/129; 264/160; 264/175; 264/284

(57) ABSTRACT

A method (110) of manufacturing footprint tiles (10) having the steps of: rolling (112) tile base (12) to a predetermined uniform thickness; imprinting (114) by utilizing a plate or roller with a plurality of convex footprints and exerting pressure upon the rolled tile base (12) forming a plurality of concave footprint impressions (14) into the tile base (12); cutting (116) by utilizing a plate or roller with a plurality of blades complementarity positioned to the plurality of concave footprint impressions (14) and exerting pressure upon the rolled tile base (12) forming individual foot print tiles (10); and drying (120) the individual foot print tiles (10).

### BACKGROUND OF THE INVENTION

### CROSS REFERENCE TO RELATED APPLICATIONS

The present application is a continuation of Document Disclosure Number 488351 filed Feb. 8, 2001.

1. Field of the Invention

The present invention relates to tiles having animal foot prints. More particularly, the present invention relates to a method of manufacturing foot print tiles.

2. Description of the Prior Art

Numerous innovations for footprint tiles have been provided in the prior art that are described as follows. Even though these innovations may be suitable for the specific individual purposes to which they address, they differ from the present invention as hereinafter contrasted.

In U.S. Pat. No. 4,068,992, invented by, Buchel, titled Apparatus for manufacturing tiles, an apparatus for manufacturing tiles by extrusion of clay or a similar material comprising a die adapted with a number of spaced apart pivotable rigid blades which are arranged such as to equalize the output speeds of several superposed layers of extruded material. Means are also provided substantially in the planes ofthe blades downstream of the outer ends thereof for projecting a pulverized powder product at right angles to the direction of extrusion into interstices between the layers. Impermeable coatings are added to the outer surfaces of the superposed layers and the assembly is then cut into piles of tiles which can then be delivered into an oven for baking, the heat ensuring removal of the impermeable coating and the separation powder product.

In U.S. Pat. No. 4,535,022, invented by, Kato, titled, Decorative tile and method for manufacturing the same, decorative tiles which may be bonded to the surfaces of columns and walls of a building are provided and a method for manufacturing the same is also disclosed. One surface of a tile blank made of a refractory material such as ceramic is coated with a metal layer by a metal spraying process so that a decorative tile looks gorgeous and even when a decorative tile is directly bonded to a concrete wall, it is not attacked or corroded.

In U.S. Pat. No. 4,661,054, invented by, Oberoi, et al., titled, Tile manufacturing apparatus, a manufacturing apparatus includes means for forming “green state” tiles on pallets. The pallets are then loaded on to racks for curing. The apparatus for loading the pallets on to shelves in the racks comprises pairs of supports which are carried by conveyors. The pairs of supports engage edges of the pallets and the conveyors move upwards to pick up the pallets as they are fed in timed relation to the apparatus by an infeed conveyor which also ensures that the pallets remain level as they are loaded. When all the supports are carrying a tile, a pusher pushes the pallets onto shelves in the racks.

In U.S. Pat. No. 5,080,959, invented by, Tanaka, et al., titled, Multilayer tile and method of manufacturing same, a multilayer tile, wherein the tile-materials of the first and third layers are substantially equal to each other in shrinkage during drying and firing and in thermal expansion coefficient after firing.

In U.S. Pat. No. 5,398,458, invented by, Henriksen, et al., titled, Process of manufacturing stone tile mosaics and apparatus therefor, a process of and apparatus for manufacturing tile mosaics from at least two stone slabs, such as marble or granite slabs. The process comprises the steps of: a) cutting each of the two slabs into a matrix of pieces while maintaining the original orientation of the pieces, b) classifying the pieces of each matrix into two or more sets of pieces, c) intermixing a first set of pieces of one slab with a second set of pieces of another slab while maintaining the original orientation of the pieces, thereby forming the mosaic.

In U.S. Pat. No. 5,830,551, invented by, Kakamu, et al., titled, Method for manufacturing a patterned tile, a method for manufacturing a tile having a desired pattern. The pattern goes through the tile in the thickness direction. For manufacturing such a tile, e.g. a partition plate 84 is disposed in a pressure forming die 91 so as to divide its inside space into an outer forming space 95 and an inner forming space 96. Light black granules and light red granules are filled respectively in the outer and inner forming spaces 95, 96. Then, the partition wall 84 is taken out from the die 91, and lining granules are filled over the colored granules. Thereafter, they are pressed into one body and burned.

In U.S. Pat. No. 5,834,081, invented by, Fanti, titled, Tiles, method of manufacturing tiles from plastic material and equipment for facilitating such manufacture, a plastics tile (9) is made up of a plurality of discrete plastics pieces (10, 11, 12) which are shaped relative to each other and assembled together to abut edge to edge in lower regions of the pieces and form a recess above each mutually abutting edge of abutting pieces in upper regions of the pieces. The pieces are joined together along said mutually abutting edges below the recesses to form a unitary tile.

In U.S. Pat. No. 5,927,034, invented by, Cole, titled, Flexible cement textured building tile and tile manufacturing process, a building tile for covering a building surface includes a flexible backing layer having a rearward face for securing to the building surface and a forward face; and a flexible cement layer secured to the forward face. The tile preferably additionally includes adhesive material, where at least part of the rearward face is covered with the adhesive material for mounting the tile to the building surface. The flexible cement layer is preferably textured to be aesthetically appealing. The flexible cement layer preferably includes a mixture of a cement aggregate; an acrylic resin; a water-based paint; and a waterproof rubber material. The backing layer may be formed of laminate sheet material, peg board or formica sheet material. A process is also provided of manufacturing a building tile, including the steps of providing a flexible backing layer having a backing layer forward face and a backing layer rearward face; abrading the backing layer forward face; mixing an aggregate cement with an acrylic resin until a false set is reached; mixing into the aggregate cement and acrylic resin mixture a waterproof rubber material; and spreading the mixture over the backing layer forward face. The process preferably includes the additional steps of adding adhesive as needed to reach a mixture consistency suitable for spreading, coloring the mixture, texturing the mixture, and sealing the mixture using with a surface sealer.

In U.S. Pat. No. 6,027,599, invented by, Wang, titled, Method for manufacturing knockdown safety soft floor tile, a method for manufacturing knockdown safety soft floor tiles. The method includes steps of cleaning up an oil layer on the surface of the EVA board, using photography to print a predetermined picture on transfer printing paper, attaching the transfer printing paper with the picture to the surface of the EVA board, rolling and compressing the transfer printing paper with a high temperature roller, tearing away the transfer printing paper and leaving the picture on the EVA board and cutting the EVA board to have predetermined dimensions defining a floor tile.

Numerous innovations for footprint tiles have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to tiles having animal or human foot prints. More particularly, the present invention relates to a method of manufacturing foot print tiles.

The types of problems encountered in the prior art are tiles have flat prints but do not have 3-Dimensional indicia.

In the prior art, unsuccessful attempts to solve this problem were attempted namely: printing animal footprint indicia on tiles. However, the problem was solved by the present invention because the tiles did not have 3-Dimensional features.

Innovations within the prior art are rapidly being exploited in the field of manufacturing tiles.

The present invention went contrary to the teaching of the art which describes and claims indicia printed tiles.

The present invention solved a long felt need for a 3-Dimensional animal footprint tile.

Accordingly, it is an object of the present invention to provide a foot print tile having a tile base, footprint impression, and coating.

More particularly, it is an object of the present invention to provide a method of manufacturing footprint tiles having the step of rolling tile base to a predetermined uniform thickness.

In keeping with these objects, and with others which will become apparent hereinafter, one feature of the present invention resides, briefly stated, in the method of manufacturing footprint tiles having the step of imprinting by utilizing a plate or roller with a plurality of convex footprints and exerting pressure upon the rolled tile base forming a plurality of concave footprint impressions into the tile base.

When the method of manufacturing footprint tiles is designed in accordance with the present invention, it has a step of cutting by utilizing a plate or roller with a plurality of blades complementarity positioned to the plurality of concave footprint impressions and exerting pressure upon the rolled tile base forming individual foot print tiles.

In accordance with another feature of the present invention, the method of manufacturing footprint tiles has the step of applying coating on the individual foot print tiles.

Another feature of the present invention is that the the method of manufacturing footprint tiles has the step of drying the individual foot print tiles.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### LIST OF REFERENCE NUMERALS UTILIZED IN THE DRAWINGS

### Embodiment

10—foot print tile (10)

12—tile base (12)

14—footprint impression (14)

16—coating (16)

### Method of Manufacturing Footprint Tiles

110—method of manufacturing footprint tiles (110)

112—rolling (112) tile base (12) to a predetermined uniform thickness

114—imprinting (114) by utilizing a plate or roller with a plurality of convex footprints and exerting pressure upon the rolled tile base (12) forming a plurality of concave footprint impressions (14) into the tile base (12)

116—cutting (116) by utilizing a plate or roller with a plurality of blades complementarity positioned to the plurality of concave footprint impressions (14) and exerting pressure upon the rolled tile base (12) forming individual foot print tiles (10)

116A—applying (116A) coating on the individual foot print tiles (10)

118—drying (120) the individual foot print tiles (10)

### BRIEF DESCRIPTION OF THE DRAWINGS

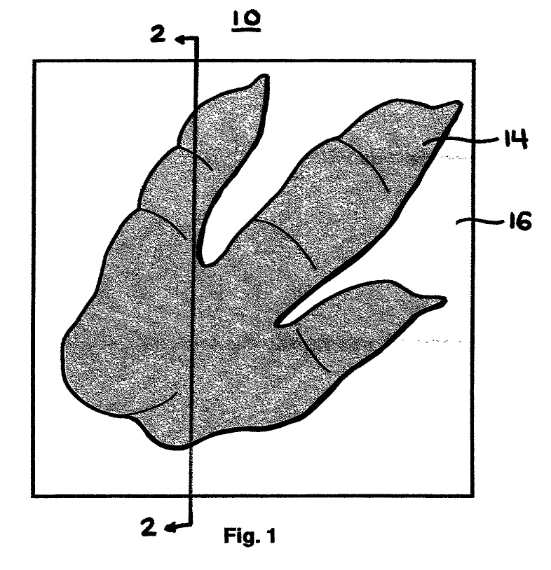

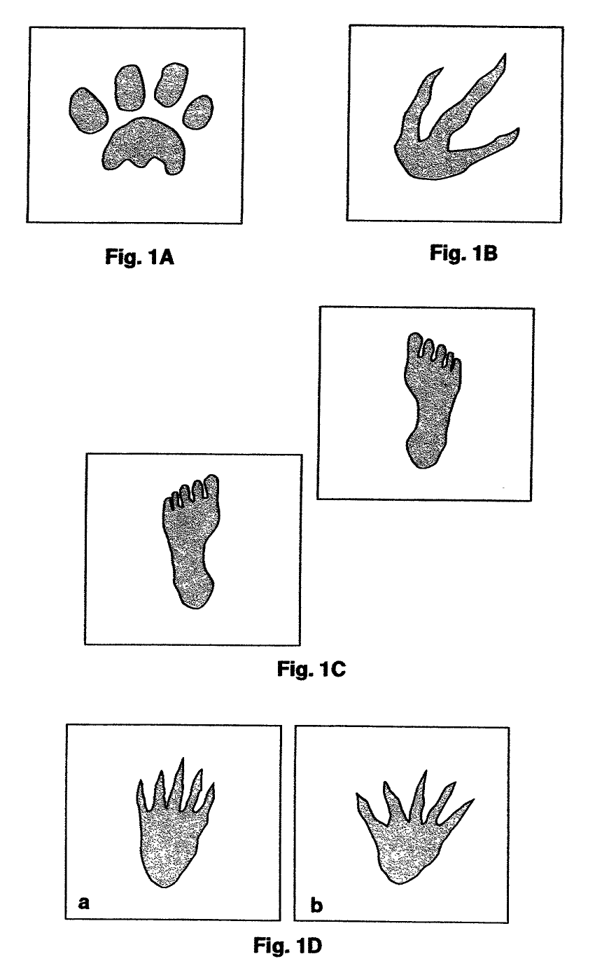

FIG. 1 is a top view of a dinosaur foot print tile (10).

FIG. 1A is a top view of a dog foot print tile (10).

FIG. 1B is a top view of a bird foot print tile (10).

FIG. 1C is a top view of a monkey foot print tile (10).

FIG. 1D is a top view of a racoon foot print tile (10).

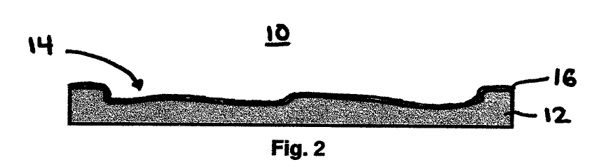

FIG. 2 is a cross sectional view along LINE 2-2 of FIG. 1.

### DESCRIPTION OF THE PREFERRED EMBODIMENT

Referring to FIG. 1 which is a top view of a dinosaur foot print tile (10). The method (110) of manufacturing footprint tiles (10) comprises the step of rolling (112) tile base (12) to a predetermined uniform thickness. Preferably, the thickness is between ¼ and 1 inch.

Referring to FIG. 2 which is a cross sectional view along LINE 2-2 of FIG. 1. The method (11) further consists of the step of imprinting (114) by utilizing a plate or roller with a plurality of convex footprints and exerting pressure upon the rolled tile base (12) forming a plurality of concave footprint impressions (14) into the tile base (12). The plate can be utilized in conjunction with a conveyor belt upon which the tile base (12) is advanced to a predetermined distance and the plate “stamps” the footprint impression into the tile base (12). Alternatively, a roller containing convex footprints can either roll along the top of the tile base (12) or remain in rotationally mounted one position wherein the tile base (12) moves along on a conveyor thereunder.

The method (11) further consists of the step of cutting (116) by utilizing a plate or roller with a plurality of blades complementarity positioned to the plurality of concave footprint impressions (14) and exerting pressure upon the rolled tile base (12) forming individual foot print tiles (10). The blades must be contiguous such that individual footprint tiles (10) are formed by cutting. It is necessary to properly position the blades to cut around the footprint impressions (14) positioning them in an approximate central position on the footprint tile (10) face. The blades can cut footprint tiles (10) into different sizes and shapes which are complimentary and can be installed (laid) with small equidistance spaces there between.

The method (11) further consists of the step of drying (120) the individual foot print tiles (10). Which is usually accomplished using a kiln, oven or baking in sunlight.

Optionally, the method (11) may further consist of the step applying (116A) coating on the individual foot print tiles (10) which functions to protect and preserve the tile base (12) during use. The tile base (12) is selected from a group consisting of clay, clay composites, plastic, plastic composites, fiberglass, epoxy, rubber and rubber composites. Preferably, the tile base (12) is clay or clay composite and the the coating is glaze.

FIGS. 1A, 1B, 1C, and 1D are top views of a dog foot print tile (10), bird foot print tile (10), monkey foot print tile (10), and racoon foot print tile (10), respectively. Preferably, the concave footprint impressions are animal footprints which are selected from a group consisting of dinosaur footprints, ostrich footprints, monkey footprints, cat footprints, dog footprints, racoon footprints, and bird footprints, and any other animal or homo sapien footprint.

It will be understood that each of the elements described above, or two or more together, may also find a useful application in other types of constructions differing from the type described above.

While the invention has been illustrated and described as embodied in footprint tiles, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A method (110) of manufacturing footprint tiles (10) comprising the steps of:
A) rolling (112) tile base (12) to a predetermined uniform thickness;
B) imprinting (114) by utilizing a plate or roller with a plurality of convex footprints and exerting pressure upon the rolled tile base (12) forming a plurality of concave footprint impressions (14) into the tile base (12);
C) cutting (116) by utilizing a plate or roller with a plurality of blades complementarity positioned to the plurality of concave footprint impressions (14) and exerting pressure upon the rolled tile base (12) forming individual foot print tiles (10); and
D) drying (120) the individual foot print tiles (10).

2. The method (110) of manufacturing footprint tiles (10) as described in claim 1, further comprises the step of:
A) applying (116A) coating on the individual foot print tiles (10).

3. The method (110) of manufacturing footprint tiles (10) as described in claim 1, wherein the tile base (12) is selected from a group consisting of clay, clay composites, plastic, plastic composites, fiberglass, epoxy, rubber and rubber composites.

4. The method (110) manufacturing footprint tiles (10) as described in claim 1, wherein the concave footprint impressions are animal footprints.

5. The method (110) of manufacturing footprint tiles (10) as described in claim 4, wherein the concave animal footprint impressions are selected from a group consisting of dinosaur footprints, ostrich footprints, monkey footprints, cat footprints, dog footprints, raccoon footprints, bird footprints and any other animal or Homo sapien from the present or in the past.

6. The method (110) of manufacturing footprint tiles (10) as described in claim 2, wherein the coating is glaze
